(19) United States
(12) Patent Application Publication
(10) Pub. No.: US 2025/0358731 A1
(43) Pub. Date: Nov. 20, 2025

(54) DYNAMIC POWER SAVING OPERATION

(71) Applicant: Charter Communications Operating, LLC, St. Louis, MO (US)

(72) Inventors: Taren Geddes McCullough, Plymouth, MN (US); Aaron Matthew Nead, Highlands Ranch, CO (US); Eric Duane Hybertson, Littleton, CO (US); Ryan Loaiza, Brighton, CO (US)

(21) Appl. No.: 18/663,958

(22) Filed: May 14, 2024

(51) Int. Cl. H04W 52/02; H04W 84/12

(52) U.S. Cl. CPC H04W 52/0206; H04W 84/12

(57) ABSTRACT

A wireless customer premises equipment (CPE) associated with a local area network (LAN) is operable to communicate with one or more upstream devices in a wired WAN mode and a cellular WAN mode. The wireless CPE may detect a power-saving trigger. In response, the wireless CPE may transition from the wired WAN mode to the cellular WAN mode and may implement a first action to reduce an amount of power used by the wireless CPE.

### BACKGROUND

A subscriber (e.g., customer) may obtain network access from a service provider, such as an internet service provider (ISP). To provide the network access service, the service provider may install or provision a customer premises equipment (CPE), such as a wireless CPE and/or a wired CPE, at the customer's premises (e.g., home, business) that implements a local area network (LAN). In some examples, client devices (e.g., computers, mobile devices, smart appliances, etc.) may connect to the LAN via a wireless CPE, such as a wireless access point (AP), thereby obtaining a connection to the Internet.

### SUMMARY

The examples disclosed herein provide dynamic power-saving operations by a wireless customer premises equipment (CPE) associated with a local area network (LAN) in response to a power-saving trigger.

In one implementation, a method is provided. The method includes detecting, by a wireless customer premises equipment (CPE) associated with a local area network (LAN), a power-saving trigger. The method further includes, in response to detecting the power-saving trigger, implementing, by the wireless CPE, a first action to reduce an amount of power used by the wireless CPE.

In another implementation, a wireless customer premises equipment (CPE) is provided. The wireless CPE includes a memory and a processor device. The processor device is operable to detect a power-saving trigger. The processor device is further operable to, in response to detecting the power-saving trigger, implement a first action to reduce an amount of power used by the wireless CPE. The wireless CPE is associated with a local area network (LAN).

In another implementation, a non-transitory computer-readable storage medium is provided. The non-transitory computer-readable storage medium includes executable instructions configured to cause one or more processor devices to detect a power-saving trigger and, in response to detecting the power-saving trigger, implement a first action to reduce an amount of power used by a wireless customer premises equipment (CPE).

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for dynamically providing power-saving operations according to one implementation;

FIGS. 2A-2D are flowcharts of a method for dynamically providing power-saving operations according to one implementation;

FIG. 3 is a sequence diagram illustrating messages communicated between and actions taken by certain components illustrated in FIG. 1 to dynamically switch between a wired WAN mode and a cellular WAN mode based on a status of a power source according to one implementation; and

FIG. 4 is a flowchart of a method for dynamically providing power-saving operations according to one implementation; and

FIG. 5 is a block diagram of a wireless customer premises equipment (CPE) suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A subscriber (e.g., customer) may obtain network access from a service provider, such as an internet service provider (ISP). To provide the network access service, the service provider may install or provision a customer premises equipment (CPE), such as a wireless CPE and/or a wired CPE, at the customer's premises (e.g., home, business) that implements a local area network (LAN). In some examples, client devices (e.g., computers, mobile devices, smart appliances, etc.) may connect to the LAN via a wireless CPE, such as a wireless access point (AP), thereby obtaining a connection to the Internet.

Wireless CPEs (e.g., wireless APs) that are installed at the customer's premises typically operate with a constant power supply from a grid power source. During normal operation, such wireless CPEs do not implement any power-saving actions, such as tuning power consumption based on connected client devices. By way of non-limiting example, during normal operation, a wireless CPEs may consume excess power by configuring its radios for maximum performance, which may lead to premature wear on its components and higher energy bills for the customer.

During a power outage or power interruption (e.g., from the grid power source), some wireless CPEs are no longer able to provide network access to the client devices because upstream CPEs (e.g., cable modem, optical network unit (ONU), etc.) likewise lose power, thereby severing the connection to the service provider's network. As such, some wireless CPEs include a backup power source, such as a battery, that provides a power supply to the wireless CPE during power outages. Additionally, some wireless CPEs further include a cellular module that provides internet connectivity via a cellular network. However, internet connectivity via cellular networks typically creates a bottleneck that drastically limits northbound throughput which, in turn, degrades network performance for the client devices. Moreover, because wireless CPEs typically do not implement power-saving operations, wireless CPEs are unable to provide internet connectivity via cellular networks for long periods of time.

By way of non-limiting example, a subscriber may have a wireless CPE that includes a backup power source and a cellular module. During a power outage (e.g., from the grid power source), the wireless CPE may provide internet connectivity through a cellular network (via the cellular module). However, the wireless CPE does not adjust its configuration to conserve battery power or operate more efficiently based on the client devices connected to it. In fact, some wireless CPEs are unable to distinguish between a power supply from the grid power source and a power supply from the backup power source. Similarly, some wireless CPEs are unable to identify when bottleneck conditions occur, which prevents such wireless CPEs from reconfiguring to operate more efficiently.

The embodiments disclosed herein provide a solution to these problems by providing a wireless CPE operable to dynamically implement one or more power-saving operations during power outage conditions. As will be discussed in greater detail below, wireless CPEs of the present disclosure may monitor and store client device collection information for at least one client device connected to a LAN serviced by the wireless CPE. It should be understood that, as used herein, “client device collection information” may include any suitable network-related metric or channel quality indicator (CQI), such as respective throughput requirements for each client device connected to the LAN, actual current bandwidth usage for each client device, signal quality metrics for each client device connected to the LAN (e.g., received signal strength indicator (RSSI), signal-to-noise ratio (SNR), reference signal received power (RSRP), reference signal received quality (RSRQ), signal-to-interference-plus-noise ratio (SINR), etc.), traffic requirements, and/or the like. In the event of a power outage and/or interruption in supply from a grid power source, wireless CPEs of the present disclosure may implement a variety of power-saving operations and actions based on the client device collection information, such as steering connected client devices to low-power channels, adjusting bandwidth, reconfiguring wired ports in low power idle modes, etc. Although the examples are described herein in the context of a power-saving trigger comprising a power outage condition and/or a power interruption, the examples disclosed herein are not limited to any particular power-saving trigger, which may include, by way of non-limiting examples, a power-saving trigger that comprises a receipt of an instruction to enter a power-saving mode, or a determination of a condition by the wireless CPE that comprises a power-saving trigger.

The present disclosure provides a number of technical effects and benefits, including improvements to computing technology. As one example, the present disclosure may provide a wireless CPE that dynamically adapts between a variety of operational modes (e.g., in terms of data rate and coverage) based on the specific client devices connected to the LAN. In this way, network performance for the connected client devices may be improved. Furthermore, by dynamically adapting based on the specific client devices, wireless CPEs of the present disclosure efficiently reduce power consumption, reduce backup power source usage during power outage conditions, and extend a lifespan of a backup power source. Moreover, the embodiments disclosed herein provide power-saving solutions that are dynamic, efficient, and scalable across a plurality of premises serviced by a service provider.

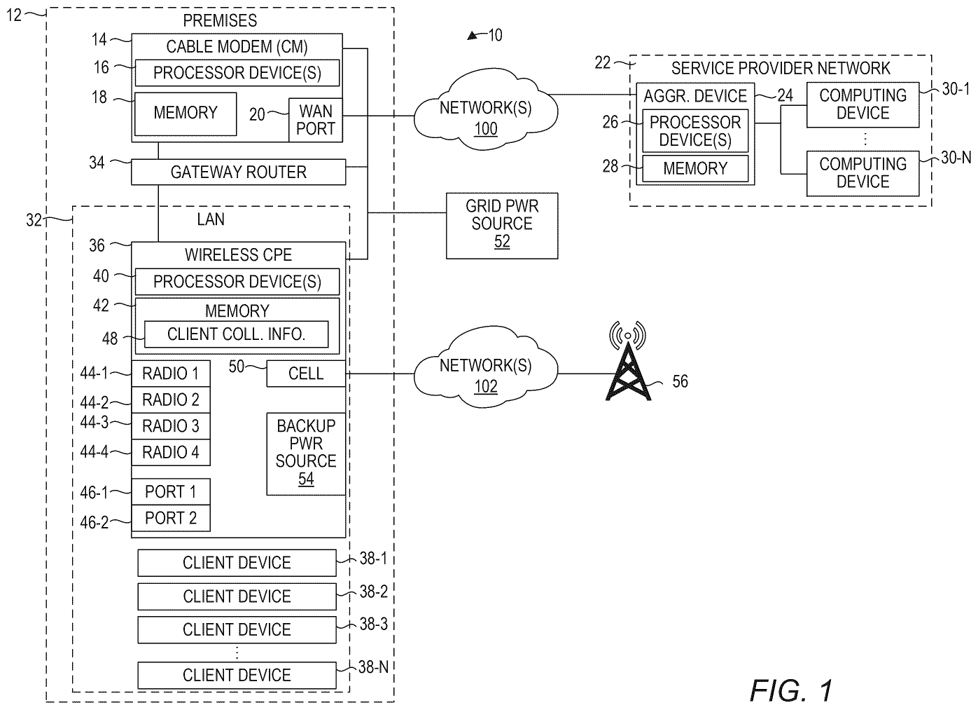

FIG. 1 is a block diagram of an environment 10 suitable for implementing one or more of the methods and/or processed disclosed herein, such as dynamically implementing power-savings operations by a wireless customer premises equipment (CPE) according to some embodiments. The environment 10 includes a customer premises 12. The customer premises 12 is associated with a customer. For instance, the customer premises 12 may be a customer's home, business, and/or other premises. The customer premises 12 may include an access device, such as a modem, such as a cable modem 14 (e.g., a D4.0 cable modem). It should be understood that the customer premises 12 may include any suitable customer premises equipment (CPE) device without deviating from the scope of the present disclosure.

As shown, the cable modem 14 includes processor device(s) 16 and a memory 18. The processor device(s) 16 may include any computing or electronic device capable of executing software instructions to implement the functionality described herein. The memory 18 can be or otherwise include any device(s) capable of storing data, including, but not limited to, volatile memory (random access memory, etc.), non-volatile memory, storage device(s) (e.g., hard drive(s), solid state drive(s), etc.).

The cable modem 14 may be operable to access other networks, such as a wide-area network (WAN) 100 (e.g., a hybrid fiber-coaxial network and/or distributed access architecture (DAA) network), through a network interface (e.g., WAN port 20). For instance, in some implementations, the WAN port 20 may be a coaxial interface operable to communicate over a coaxial data line. The WAN port 20 may include RF front-end circuitry that does suitable demodulation on data received via the network 100, such as data received from a service provider network 22 via network 100, and suitable modulation for data sent by the cable modem 14 to the service provider network 22 via the network 100. In addition, the cable modem 14 may include or be communicatively coupled to diplexers, splitters, and combiners that enable the cable modem 14 to operate in different frequency plans as specified in the DOCSIS 4.0 PHY specification. In addition, the cable modem 14 may include the RF front-end circuit for the cable modem 14. This RF front-end circuit demodulates the downstream DOCSIS signals for processing by the cable modem 14 and modulates the upstream DOCSIS signals from the cable modem 14 for transmission via the WAN port 20. Although illustrated separately from the service provider network 22, in some implementations the network 100 may be part of the service provider network 22.

The service provider network 22 includes an aggregation device 24. The aggregation device 24 includes a processor device 26 and a memory 28, and provides services such as, by way of non-limiting example, internet access and/or voice services, to a plurality of premises, such as premise 12. The aggregation device 24 may be any suitable aggregation device, such as a cable management termination system (CMTS), an optical line terminal (OLT), and/or the like. The service provider network 22 may further include a plurality of server computing devices 30-1-30-N (e.g., DHCP server(s), configuration server(s), firmware server(s), and/or the like). Alternatively, in some implementations, the service provider network 22 may be one or more computing devices (e.g., computing device 30-1) within a computing environment that includes multiple distributed devices and/or systems. It should be understood that the service provider network 22 is depicted with multiple computing devices and multiple server computing devices for purposes of illustration and discussion.

The cable modem 14 may be communicatively coupled to one or more CPEs associated with a local area network (LAN) 32, such as a gateway router 34 and a wireless CPE 36. In some examples, such as that depicted in FIG. 1, the wireless CPE 36 is a wireless access point (AP) that connects to one or more client devices 38-1-38-N(collectively, “client devices 38”) and communicates with the gateway router 34 to provide layer 3 connectivity to other client devices of other networks. Additionally and/or alternatively, in some examples, the gateway router 34 may be integrated into the wireless CPE 36 to provide layer 3 connectivity between the client devices 38 and other client devices of other networks. In some examples, the gateway router 34 and the cable modem 14 may be integrated into the wireless CPE 36.

The wireless CPE 36 includes processor device(s) 40 and a memory 42. The processor device(s) 40 may include any computing or electronic device capable of executing software instructions to implement the functionality described herein. The memory 42 can be or otherwise include any device(s) capable of storing data, including, but not limited to, volatile memory (random access memory, etc.), non-volatile memory, storage device(s) (e.g., hard drive(s), solid state drive(s), etc.).

The wireless CPE 36 is operable to communicate with the client devices 38 via any of a plurality of different frequency bands. More particularly, the wireless CPE 36 includes a plurality of radios 44 operable to implement the plurality of different frequency bands. By way of non-limiting example, the wireless CPE 36 may include a radio 44-1 that implements a 6 gigahertz (GHz) frequency band, a radio 44-2 that implements a 5 gigahertz (GHz) frequency band, and a radio 44-3 that implements a 2.4 gigahertz (GHz) frequency band. The wireless CPE 36 may further include a radio 44-4 operable to implement an Internet of Things (IoT) frequency band, such as any suitable frequency band for “always-on” (e.g., automated) devices (e.g., thermostats, doorbell cameras, printers, etc.) that may not use or require significant amounts of bandwidth to function properly. Each radio 44 includes an array of multiple input, multiple output (MIMO) antennas that simultaneously transmit and receive data. In some examples, each radio 44 may be configured based on a radio chain setting, which defines how many of the MIMO antennas transmit (Tx) and how many of the MIMO antennas receive (Rx). By way of non-limiting example, each radio 44 may be configured as a 4×4 MIMO chain (e.g., four Tx, four Rx), a 3×3 MIMO chain (e.g., three Tx, three Rx), and/or a 2×2 MIMO chain (e.g., two Tx, two Rx). It should be understood that each radio 44 may include any suitable antenna without deviating from the scope of the present disclosure, such as any suitable active antenna, any suitable passive antenna, and/or the like.

The wireless CPE 36 is also operable to communicate with the client devices 38 via a plurality of wired ports 46 (e.g., wired port 46-1, wired port 46-2). Each wired port 46-1-46-2 is operable to connect with an Ethernet cable. Each of the wired ports 46 may be operable to transmit data (via a wired connection) via a plurality of bandwidths. In some examples, the wired ports 46 may also be operable to provide direct current (DC) power to the wireless CPE 36 (e.g., via Power over Ethernet (POE)). Hence, a connection type between the client devices 38 and the wireless CPE 36 may include a wireless connection type (e.g., via radios 44) and/or a wired connection type (e.g., via wired ports 46).

In some examples, the wired ports 46-1-46-2 are configured to transmit data at a first bandwidth during normal operation; the wired ports 46-1-46-2 are configured to transmit data at a second bandwidth during power-saving operations, because the wireless CPE 36 uses less power to transmit data at the second bandwidth than the first bandwidth.

The wireless CPE 36 is operable to monitor, and subsequently store in the memory 42 and/or any suitable data bank, client device connection information 48. By way of non-limiting example, the client device connection information 48 includes a connection type of each client device 38-1-38-N connected to the LAN 32 (e.g., wired, wireless), a total throughput required by each client device 38-1-38-N connected to the LAN 32, a CQI (e.g., RSSI) for each client device 38-1-38-N connected to the LAN 32, and/or the like.

The wireless CPE 36 includes a cellular module 50 that provides internet connectivity via a wireless link. The cellular module 50 is operable to provide for communication over a wireless WAN network, such as a cellular network 102 (e.g., Fourth Generation (4G) networks, Fifth Generation (5G) networks, etc.). Thus, the wireless CPE may communicate with upstream devices (e.g., service provider network 22) in a wired wide-area network (wired WAN) mode via the network 100 and/or with upstream devices (e.g., cellular base station 56) in a cellular wide-area network (cellular WAN) mode via the network 102.

The wireless CPE 36 may operate with a constant power supply from a grid power source 52 during normal operation. The grid power source 52 may provide constant alternating current (A/C) power from the electrical grid (not shown) to the premises 12. Hence, the cable modem 14, the gateway router 34, the wireless CPE 36, and some of the client devices 38-1-38-N may receive power from the grid power source 52. As such, in the event of a power outage or power interruption (e.g., from grid power source 52), the wireless CPE 36 is no longer able to provide network connectivity to the client devices 38-1-38-N via the network 100, because the upstream CPEs (e.g., cable modem 14, gateway router 34, etc.) no longer receiving power from a power supply.

However, the wireless CPE 36 may still operate during a grid supply power outage. As shown, the wireless CPE 36 may include a backup power source 54, such as one or more batteries. In some examples, the backup power source 54 may be integral with the wireless CPE 36. In other examples, the backup power source 54 may be integral with a backup battery unit (not shown) that is electrically coupled to the wireless CPE 36.

Although the wireless CPE 36 ceases to provide network connectivity to the client devices 38-1-38-N via the network 100, the wireless CPE 36 is operable to provide network connectivity to the client devices 38-1-38-N via the network 102 (via the cellular module 50). However, network connectivity via the cellular module 50 often causes bottlenecks for northbound data transmission (e.g., transmission from client device 38-1-38-N to the upstream cellular base station 56 via network 102), because the maximum achievable data rate of the wireless CPE 36 is defined by the lowest data rate between either the client devices 38-1-38-N and the wireless CPE 36 (i.e., “LAN-side”) or the wireless CPE 36 and the network 102 (e.g., “network-side”).

Typically, during power outage conditions (e.g., connectivity via network 102), the data rate between the wireless CPE 36 and the network 102 is lower than the data rate between the client devices 38-1-38-N, because much of the high bandwidth capacity associated with the network 100 is provided by the upstream CPEs (e.g., cable modem 14, gateway router 34) and because a maximum cellular bandwidth of the networks 102 is often lower than a maximum wired bandwidth of the networks 100. Moreover, during normal operations (e.g., power from grid power source 52), the radios 44 and wired ports 46 are configured for maximum client performance, which outpaces the throughput capabilities of the network 102. Thus, during power outage conditions, a bottleneck may be created based on the diminished data rate associated with the network 102.

As described herein, in some examples, the wireless CPE 36 is operable to dynamically configure the radios 44 and the wired ports 46 in response to detecting a power-saving trigger, such as during power outage conditions and/or when the wireless CPE 36 is configured in a power-saving mode, in order to prolong the lifespan of the backup power source 54. As such, the wireless CPE 36 reduces its power usage by efficiently configuring the radios 44 and wired ports 46, which extends the operating life of the backup power source 54 and maintains network performance (e.g., for the client devices 38-1-38-N).

More particularly, in examples where the power-saving trigger is a power outage condition, the wireless CPE 36 may transition from the grid power source 52 to the backup power source 54. In some examples, prior to transitioning, the wireless CPE 36 may detect a voltage drop indicative of an outage associated with the grid power source 52. Additionally and/or alternatively, in some examples, the wireless CPE 36 may receive a data transfer from the backup power source 54 indicating that the backup power source 54 is now powering the wireless CPE 36. In response, the wireless CPE 36 performs a first action to reduce an amount of power used by the wireless CPE 36.

More particularly, the wireless CPE 36 may monitor and store (e.g., in memory 42) client device collection information 48 during normal operation (e.g., prior to transitioning from the grid power source 52 to the backup power source 54. The wireless CPE 36 may determine a connection type (e.g., wired via wired ports 46, wireless via radios 44) of at least one client device 38 connected to the LAN 32 based on the client device collection information 48 and may implement the first action based on the connection type of the client device 38. The wireless CPE 36 may monitor and store the client device collection information 48 at any suitable interval, such as every 100 milliseconds, every second, every two seconds, or the like. The client device collection information 48 may include the current real-time bandwidth utilization of each client device at each such interval. The client device collection information 48 may also include, for each client device, detailed connection information such as the particular frequency band used by the client device, and the like.

As one illustrative example, the wireless CPE 36 may determine that a first client device 38-1 is connected to a first radio 44-1. The first radio 44-1 may implement a first frequency band, such as the 6 GHz frequency band. In such instances, the wireless CPE 36 may transmit a bandsteering message to the first client device 38-1, which causes the first client device 38-1 to connect to a second radio 44-2 implementing a second frequency band (e.g., 5 GHz, 2.4 GHz), and may disable the first radio 44-1 to reduce the amount of power used by the wireless CPE 36.

As another illustrative example, the wireless CPE 36 may determine that a second client device 38-2 is connected to the second radio 44-2. As noted above, the second radio 44-2 may implement the second frequency band (e.g., 5 GHz, 2.4 GHz). In response, the wireless CPE 36 may determine a bandwidth setting and a radio chain setting for the second radio 44-2 based on the client device collection information 48 associated with the second client device 38-2. For instance, the wireless CPE 36 may determine the bandwidth setting for the second radio 44-2 based on a total throughput required to service the second client device 38-2. The wireless CPE 36 may determine the radio chain setting for the second radio 44-2 based on a signal strength (e.g., RSSI) of the second client device 38-2. Subsequently, the wireless CPE 36 may configure the second radio 44-1 based on the determined bandwidth setting and radio chain setting.

Alternatively, the wireless CPE 36 may determine that the first client device 38-1 and the second device 38-2 are connected to the second radio 44-2. In response, the wireless CPE 36 may determine the bandwidth setting for the second radio 44-2 based on a total throughput required to service both the first client device 38-1 and the second client device 38-2. The wireless CPE 36 may determine the radio chain setting for the second radio 44-2 based on a lowest signal strength (e.g., RSSI) of the first client device 38-1 and the second client device 38-2, respectively. In this manner, the wireless CPE 36 may reduce power usage while maintaining network connectivity for both the first client device 38-1 and the second client device 38-2.

As another illustrative example, the wireless CPE 36 may determine that the first client device 38-1 is connected to a first wired port 46-1. In response, the wireless CPE 36 may reduce a bandwidth of the first wired port 46-1 from a first bandwidth to a second bandwidth that utilizes less power to transmit than the first bandwidth. Alternatively, the wireless CPE 36 may determine that no client device is connected to the first wired port 46-1. In response, the wireless CPE 36 may place the first wired port 46-1 in a low power idle mode.

It should be understood that that the power-saving operations of the present disclosure are described herein in the context of power outage conditions for ease of illustration and discussion. Those having ordinary skill in the art, using the disclosures provided herein, will understand that the example power-saving operations described herein may also be performed in response to other power-saving triggers without deviating from the scope of the present disclosure. By way of non-limiting example, in some implementations, the wireless CPE 36 may perform any of the power-saving operations described herein in response to receiving an instruction to enter into a power-saving mode from an operator of the wireless CPE 36 (e.g., a user, a customer, a service provider, etc.).

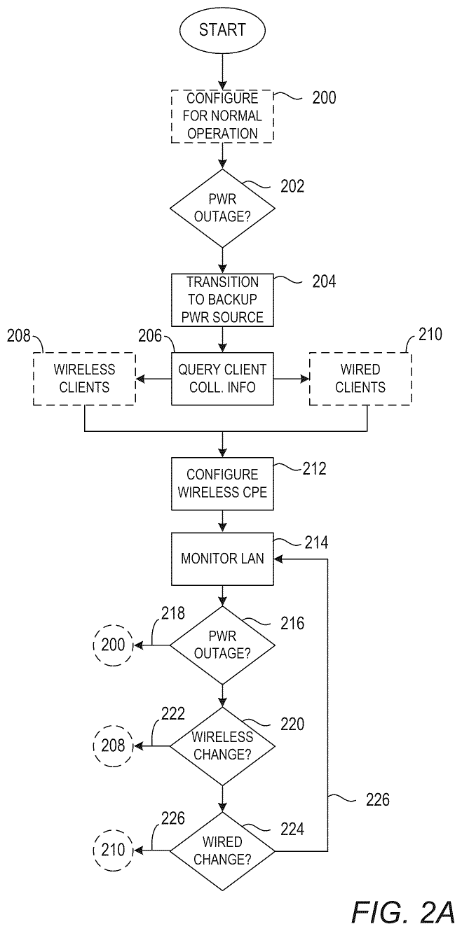

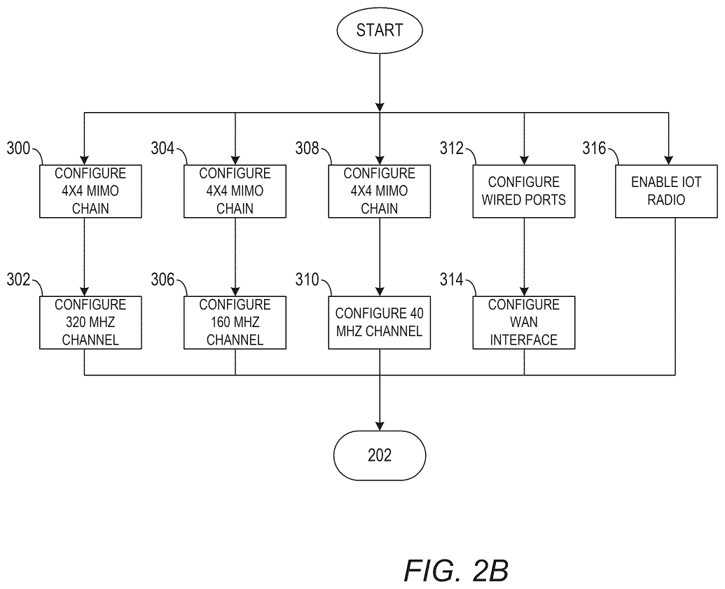

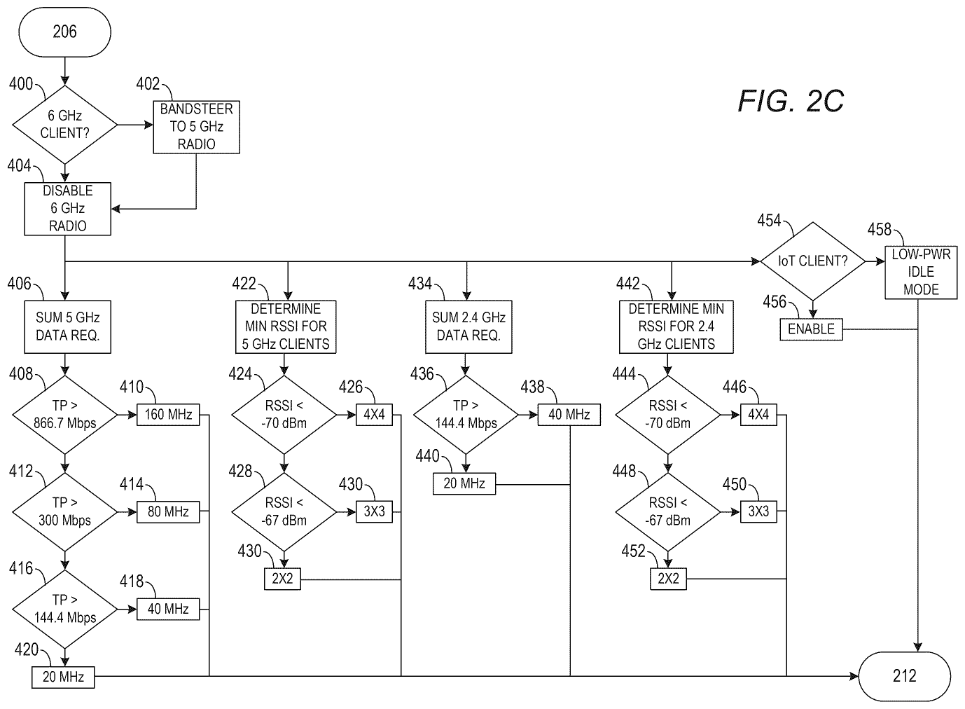

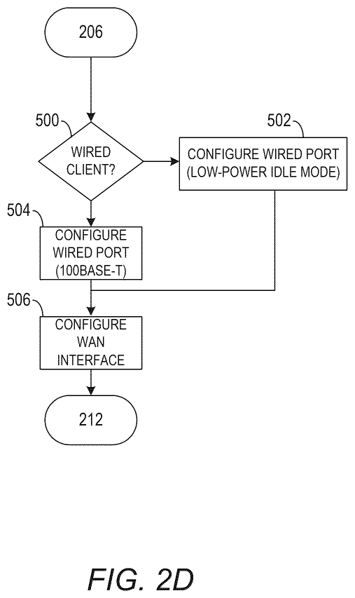

FIGS. 2A-2D are flowcharts of a method for dynamically providing power-saving operations according to one implementation of the present disclosure. FIGS. 2A-2D will be discussed in conjunction with FIG. 1. Furthermore, it should be understood that, although discussed in the context of a power outage condition, the example power-saving operations illustrated in FIGS. 2A-2D and described below are likewise applicable in implementations where the power-saving trigger is an instruction to enter into a power-saving mode.

Referring to FIG. 2A, the wireless CPE 36 configures the radios 44-1-44-4 and the wired ports 46-1-46-2 for maximum capacity and client device (e.g., client devices 38-1-38-N) performance (e.g., for normal operation) (FIG. 2A, block 200).

By way of non-limiting example, FIG. 2B is flowchart of a method for configuring the wireless CPE 36 for normal operation (e.g., for maximum capacity and client performance). Although discussed below in a particular sequential order, it should be understood that the wireless CPE 36 may perform the method depicted in FIG. 2B in any order and/or simultaneously.

Referring to FIG. 2B, the wireless CPE 36 sets the radio 44-1, which implements the 6 GHz frequency band, to operate with the standard radio chain, which is the 4×4 MIMO chain (e.g., four Tx, four Rx) (FIG. 2B, block 300). The wireless CPE 36 also sets a channel width of the radio 44-1 to a maximum bandwidth setting, which corresponds to a 320 megahertz (MHz) channel (FIG. 2B, block 302).

Subsequently and/or simultaneously, the wireless CPE 36 sets the radio 44-2, which implements the 5 GHz frequency band, to operate with the standard 4×4 MIMO chain (FIG. 2B, block 304). The wireless CPE 36 also sets a channel width of the radio 44-2 to a maximum bandwidth setting, which corresponds to a 160 megahertz (MHz) channel (FIG. 2B, block 306).

Subsequently and/or simultaneously, the wireless CPE 36 sets the radio 44-3, which implements the 2.4 GHz frequency band, to operate with the standard 4×4 MIMO chain (FIG. 2B, block 308). The wireless CPE 36 also sets a channel width of the radio 44-3 to a maximum bandwidth setting, which corresponds to a 40 megahertz (MHz) channel (FIG. 2B, block 310).

Subsequently and/or simultaneously, the wireless CPE 36 sets each wired port 46-1-46-2 to support a maximum data rate (FIG. 2B, block 312), and the WAN port 20 is configured to provide a maximum data rate between the wireless CPE 36 and a wired WAN network (e.g., network 100) (FIG. 2B, block 314.

Subsequently and/or simultaneously, the wireless CPE 36 configures and enables the radio 44-4, which implements a frequency band suitable for IoT devices (FIG. 2B, block 316).

Referring again to FIG. 2A, after configuring the wireless CPE 36 for normal (e.g., maximum) operations (FIG. 2A, block 200), the wireless CPE 36 determines whether a power outage or power interruption condition is detected for the grid power source 52 (FIG. 2A, block 202).

By way of non-limiting example, the wireless CPE 36 may detect a voltage drop indicative of an outage associated with the grid power source 52. Additionally and/or alternatively, the wireless CPE 36 may receive a data transfer from a backup power source, such as a battery backup unit (BBU) (e.g., backup power source 54), which indicates that the grid power source 52 is no longer providing grid power to the wireless CPE 36. If no power outage condition is detected, the wireless CPE 36 continues normal operations until the power outage and/or power interruption condition is detected.

When a power outage is detected, the wireless CPE 36 transitions from the grid power source 52 to the backup power source 54 (FIG. 2A, block 204). In response, the wireless CPE 36 queries the client device collection information 48 stored in memory 42 (FIG. 2A, block 206) and, based on the client device collection information 48, performs a first action to reduce an amount of power used by the wireless CPE 36 (FIG. 2A, block 208 and/or block 210). For instance, in some examples, the wireless CPE 36 may perform the first action based on a connection type of the client devices 38-1-38-N.

By way of non-limiting example, FIG. 2C is flowchart of example first actions performed by the wireless CPE 36 based on client devices having a wireless connectivity type. Although discussed below in a particular sequential order, it should be understood that the wireless CPE 36 may perform the actions depicted in FIG. 2C in any order and/or simultaneously. It should also be understood that the example first actions described below and illustrated in FIG. 2C are likewise applicable in implementations where the wireless CPE 36 receives an instruction to enter into a power-saving mode.

Referring to FIG. 2C, the wireless CPE 36 determines whether any of the client devices 38-1-38-N connected to the LAN 32 communicate with the wireless CPE 36 via a first frequency band (e.g., 6 GHz frequency band implemented by the radio 44-1) (FIG. 2C, block 400). If any of the client devices 38-1-38-N are connected to the radio 44-1, the wireless CPE 36 bandsteers any such client device 38-1-38-N connected to the radio 44-1 to the radio 44-2, which implements a second frequency band (e.g., 5 GHz frequency band) (FIG. 2C, block 402). To reduce power consumption, the wireless CPE 36 disables the radio 44-1 implementing the first (e.g., 6 GHz) frequency band (FIG. 2C, block 404).

The wireless CPE 36 also determines a bandwidth setting for the radio 44-2 (e.g., implementing the 5 GHz frequency band). More particularly, the wireless CPE 36 determines a total throughput requirement for all client devices 38-1-38-N connected to the LAN 32 that communicate with the wireless CPE 36 via the second (e.g., 5 GHz) frequency band, which is implemented by the radio 44-2 (FIG. 2C, block 406). As noted above, the total throughput requirement may be determined based on the client device collection information 48 stored in the memory 42. The wireless CPE 36 determines whether the total throughput requirement is greater than a first throughput threshold (e.g., 866.7 megabits-per-second (Mbps)) (FIG. 2C, block 408). If the total throughput requirement is greater than the first throughput threshold (e.g., 866.7 Mbps), the wireless CPE 36 determines the bandwidth setting for the radio 44-2 and sets the radio 44-2 to operate on the 160 MHz channel (FIG. 2C, block 410).

If the total throughput requirement is less than the first throughput threshold (e.g., 866.7 Mbps), the wireless CPE 36 determines whether the total throughput requirement is greater than a second throughput threshold (e.g., 300 Mbps) (FIG. 2C, block 412). If the total throughput requirement is greater than the second throughput threshold (e.g., 300 Mbps), the wireless CPE 36 determines the bandwidth setting for the radio 44-2 and sets the radio 44-2 to operate on the 80 MHz channel (FIG. 2C, block 414).

If the total throughput requirement is less than the second throughput threshold (e.g., 300 Mbps), the wireless CPE 36 determines whether the total throughput requirement is greater than a third throughput threshold (e.g., 144.4 Mbps) (FIG. 2C, block 416). If the total throughput requirement is greater than the third throughput threshold (e.g., 144.4 Mbps), the wireless CPE 36 determines the bandwidth setting for the radio 44-2 and sets the radio 44-2 to operate on the 40 MHz channel (FIG. 2C, block 418). If the total throughput requirement is less than the third throughput requirement (e.g., 144.4 Mbps), the wireless CPE 36 determines the bandwidth setting for the radio 44-2 and sets the radio 44-2 to operate on the 20 MHz channel (FIG. 2C, block 420).

Subsequently and/or simultaneously, the wireless CPE 36 determines a radio chain setting for the radio 44-2 (e.g., implementing the 5 GHz frequency band). More particularly, the wireless CPE 36 determines a minimum signal strength amongst all client devices 38-1-38-N connected to the LAN 32 that communicate with the wireless CPE 36 via the second (e.g., 5 GHz) frequency band (FIG. 2C, block 422). As noted above, the minimum signal strength may be determined based on the client device collection information 48 (e.g., RSSI) stored in the memory 42. By identifying which client device 38-1-38-N that is connected to the radio 44-2 is farthest away from the radio 44-2, the wireless CPE 36 ensures no client devices will be dropped from the LAN 32 during the power-savings operations described herein.

The wireless CPE 36 determines whether the minimum signal strength amongst the client devices 38-1-38-N connected to the radio 44-2 is less than a first signal strength threshold (e.g., −70 decibel-milliwatts (dBm)) (FIG. 2C, block 424). If the minimum signal strength amongst the client devices 38-1-38-N connected to the radio 44-2 is less than the first signal strength threshold (e.g., −70 dBm), the wireless CPE 36 determines the radio chain setting for the radio 44-2 is the standard 4×4 MIMO chain (e.g., four Tx, four Rx) (FIG. 2C, block 426).

If the minimum signal strength amongst the client devices 38-1-38-N connected to the radio 44-2 is greater than the first signal strength threshold (e.g., −70 dBm), the wireless CPE 36 determines whether the minimum signal strength amongst the client devices 38-1-38-N connected to the radio 44-2 is less than a second signal strength threshold (e.g., −67 dBm) (FIG. 2C, block 428). If the minimum signal strength amongst the client devices 38-1-38-N connected to the radio 44-2 is less than the second signal strength threshold (e.g., −67 dBm), the wireless CPE 36 determines the radio chain setting for the radio 44-2 is the 3×3 MIMO chain (e.g., three Tx, three Rx) (FIG. 2C, block 430). If the minimum signal strength amongst the client devices 38-1-38-N connected to the radio 44-2 is greater than the second signal strength threshold (e.g., −67 dBm), the wireless CPE 36 determines the radio chain setting for the radio 44-2 is the minimum 2×2 MIMO chain (e.g., two Tx, two Rx) (FIG. 2C, block 432).

It should be understood that each radio (e.g., MIMO) chain includes various microelectronic components, such as power amplifiers. As such, by reducing the radio chain setting (e.g., from a 4×4 MIMO chain to a 3×3 MIMO chain, etc.), the wireless CPE 36 reduces its overall power usage.

Subsequently and/or simultaneously, the wireless CPE 36 also determines the bandwidth setting and the radio chain setting for the radio 44-3 (e.g., implementing the 2.4 GHz). The bandwidth setting and the radio chain setting for the radio 44-3 may be determined in a similar manner as discussed above with reference to radio 44-2.

More particularly, the wireless CPE 36 determines a total throughput requirement for all client devices 38-1-38-N connected to the LAN 32 that communicated with the wireless CPE 36 via a third (e.g., 2.4 GHz) frequency band, which is implemented by the radio 44-3 (FIG. 2C, block 434). The wireless CPE 36 determines whether the total throughput requirement is greater than a first throughput threshold (e.g., 144.4 Mbps) (FIG. 2C, block 436). If the total throughput requirement is greater than the first throughput threshold (e.g., 144.4 Mbps), the wireless CPE 36 determines the bandwidth setting for the radio 44-3 and sets the radio 44-3 to operate on the 40 MHz channel (FIG. 2C, block 438). If the total throughput requirement is less than the first throughput requirement (e.g., 144.4 Mbps), the wireless CPE 36 determines the bandwidth setting for the radio 44-3 and sets the radio 44-3 to operate on the 20 MHz channel (FIG. 2C, block 440).

Subsequently and/or simultaneously, the wireless CPE 36 determines a radio chain setting for the radio 44-3 (e.g., implementing the 2.4 GHz frequency band). More particularly, the wireless CPE 36 determines a minimum signal strength amongst all client devices 38-1-38-N connected to the LAN 32 that communicate with the wireless CPE 36 via the third (e.g., 2.4 GHz) frequency band (FIG. 2C, block 442).

The wireless CPE 36 determines whether the minimum signal strength amongst the client devices 38-1-38-N connected to the radio 44-3 is less than the first signal strength threshold (e.g., −70 dBm) (FIG. 2C, block 444). If the minimum signal strength amongst the client devices 38-1-38-N connected to the radio 44-3 is less than the first signal strength threshold (e.g., −70 dBm), the wireless CPE 36 determines the radio chain setting for the radio 44-3 is the standard 4×4 MIMO chain (e.g., four Tx, four Rx) (FIG. 2C, block 446).

If the minimum signal strength amongst the client devices 38-1-38-N connected to the radio 44-3 is greater than the first signal strength threshold (e.g., −70 dBm), the wireless CPE 36 determines whether the minimum signal strength amongst the client devices 38-1-38-N connected to the radio 44-2 is less than the second signal strength threshold (e.g., −67 dBm) (FIG. 2C, block 448). If the minimum signal strength amongst the client devices 38-1-38-N connected to the radio 44-3 is less than the second signal strength threshold (e.g., −67 dBm), the wireless CPE 36 determines the radio chain setting for the radio 44-3 is the 3×3 MIMO chain (e.g., three Tx, three Rx) (FIG. 2C, block 450). If the minimum signal strength amongst the client devices 38-1-38-N connected to the radio 44-3 is greater than the second signal strength threshold (e.g., −67 dBm), the wireless CPE 36 determines the radio chain setting for the radio 44-3 is the minimum 2×2 MIMO chain (e.g., two Tx, two Rx) (FIG. 2C, block 452).

Subsequently and/or simultaneously, the wireless CPE 36 also determines whether any of the client devices 38-1-38-N connected to the LAN 32 are IoT devices (e.g., thermostats, doorbell cameras, printers, etc.) (FIG. 2C, block 454). If at least one of the client devices 38-1-38-N is an IoT device, the wireless CPE 36 enables the radio 44-4, which implements a frequency band suitable for IoT devices (FIG. 2C, block 456). If no IoT devices are connected to the LAN 32, the wireless CPE 36 configures the radio 44-4 in a low-power idle mode (FIG. 2C, block 458), which results in the wireless CPE 36 consuming less power.

Furthermore, although not depicted in FIG. 2C, the wireless CPE 36 may also reduce and/or disable various components (e.g., active antenna components) of each radio 44 to further reduce the power consumed by the wireless CPE 36.

By way of non-limiting example, FIG. 2D is flowchart of another example first actions performed by the wireless CPE 36 based on client devices having a wired connectivity type. Although discussed below in a particular sequential order, it should be understood that the wireless CPE 36 may perform the actions depicted in FIG. 2D in any order and/or simultaneously. It should also be understood that the example first actions described below and illustrated in FIG. 2D are likewise applicable in implementations where the wireless CPE 36 receives an instruction to enter into a power-saving mode.

Referring to FIG. 2D, the wireless CPE 36 determines whether any of the client devices 38-1-38-N are connected to the wired port 46-1 (FIG. 2D, block 500). If a client device 38-1-38-N is not connected to the wired ports 46-1, the wireless CPE 36 configures the wired port 46-1 in a low-power idle mode (FIG. 2D, block 502). For instance, in implementations where the wired port 46-1 is “Power-over-Ethernet” port (e.g., operable to provide DC power to the wireless CPE 36), the wireless CPE 36 may reduce and/or disable the wired port 46-1 to further reduce the power consumed by the wireless CPE 36.

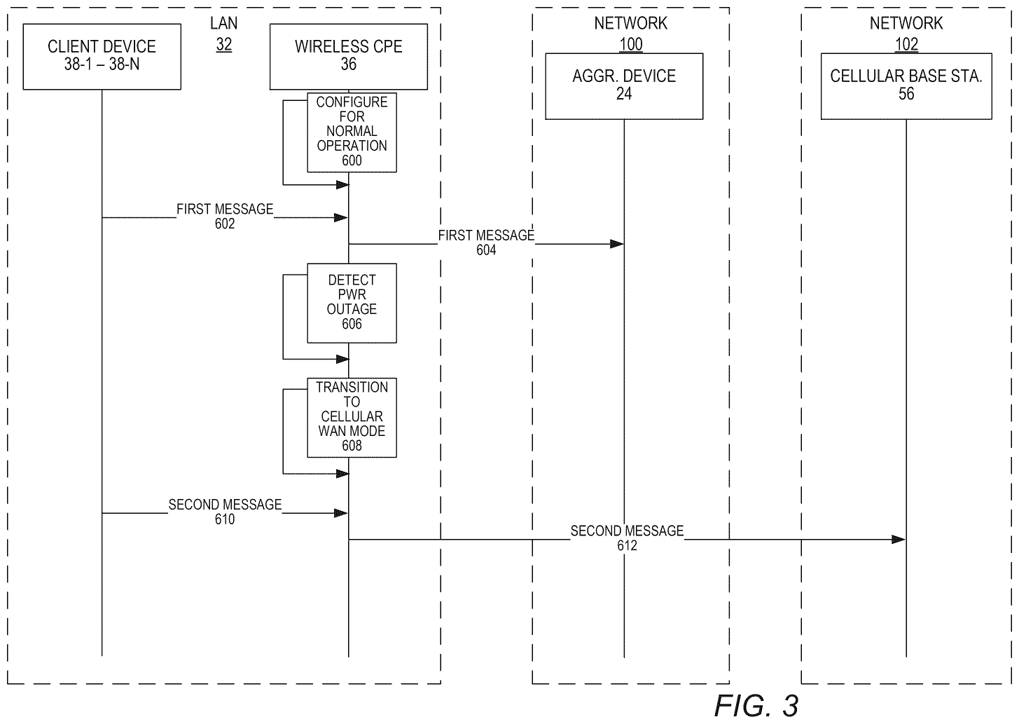

If a client device 38-1-38-N is connected to the wired port 46-1, the wireless CPE 36 reduces a bandwidth of the first wired port 46-1 from a first bandwidth (e.g., during normal operation) to a second bandwidth (e.g., 100Base-T) that utilizes less power to transmit than the first bandwidth (FIG. 3D, block 504). Although not depicted in FIG. 2D, the wireless CPE 36 may perform the same actions described above for all wired ports of the wireless CPE 36.

In some examples, the wireless CPE 36 also configures a WAN interface of the wireless CPE 36 (e.g., coupling the wireless CPE 36 to the cable modem 14 and/or the gateway router 34) in a low power idle mode (FIG. 2D, block 506).

Referring again to FIG. 2A, after configuring the radios 44-1-44-4 (FIG. 2C) and the wired ports 46-1-46-2 (FIG. 2D) (FIG. 2A, block 212), the wireless CPE 36 monitors the LAN 32 (and the client devices 38-1-38-N connected thereto) for any changes (FIG. 2A, block 214). For instance, the wireless CPE 36 monitors its power input to determine whether the power outage and/or power interruption condition is still ongoing (FIG. 2A, block 216). If power supply resumes from the grid power source 52 (FIG. 2A, block 218), the wireless CPE 36 returns to block 200 and configures the radios 44-1-44-4 and the wired ports 46-1-46-2 for normal operations.

If the backup power source 54 is still supplying power to the wireless CPE 36, the wireless CPE 36 determines whether there are any changes with the client devices 38-1-38-N having the wireless connectivity type (FIG. 2A, block 220). If the wireless CPE 36 detects changes to the client devices 38-1-38-N having the wireless connectivity type (FIG. 2A, block 222), the wireless CPE 36 returns to block 208 to reconfigure the radios 44-1-44-4 based on the detected changes.

If the wireless CPE 36 does not detect changes to the client devices 38-1-38-N having the wireless connectivity type, the wireless CPE 36 determines whether there are any changes with the client devices 38-1-38-N having the wired connectivity type (FIG. 2A, block 224). If the wireless CPE 36 detects changes to the client devices 38-1-38-N having the wired connectivity type (FIG. 2A, block 226), the wireless CPE 36 returns to block 210 to reconfigure the wired ports 46-1-46-2 based on the detected changes. If the wireless CPE 36 does not detect changes to the client devices 38-1-38-N having the wired connectivity type, the wireless CPE 36 returns to block 214 to continue monitoring the LAN 32.

FIG. 3 is a sequence diagram illustrating messages communicated between and actions taken by certain components illustrated in FIG. 1 to dynamically switch between a wired WAN mode and a cellular WAN mode based on a status of a power source according to one implementation of the present disclosure. Hence, the power-saving trigger in FIG. 3 is associated with a power-outage condition. However, it should be understood that the example power-saving operations illustrated in FIG. 3 and described below are likewise applicable in implementations where the power-saving trigger is an instruction to enter into a power-saving mode. FIG. 3 will be discussed in conjunction with FIG. 1.

The wireless CPE 36 configures the radios 44-1-44-4 and the wired ports 46-1-46-2 for normal operation (FIG. 3, step 600). As noted above, during normal operation, the wireless CPE 36 is in a wired WAN mode and is operable to communicate with upstream client devices via a wired WAN network, such as network 100. The wireless CPE 36 receives a first message, which is destined for another network (e.g., network 100), from a client device (e.g., client devices 38-1-38-N) operating on the LAN 32 (FIG. 3, step 602). The wireless CPE 36 sends the first message to an upstream device, such as the aggregation device 24 of the service provider network 22, via the wired WAN network (e.g., network 100) (FIG. 3, step 604).

The wireless CPE 36 detects a power outage associated with the grid power source 52 (e.g., a power-saving trigger) and, in response, transitions to the backup power source 54 (FIG. 3, step 606). In response to transitioning from the grid power source 52 to the backup power source 54, the wireless CPE 36 transitions from the wired WAN mode to a cellular WAN mode (FIG. 3, step 608). As noted above, during power outage conditions, the wireless CPE 36 is in a cellular WAN mode and is operable to communicate with upstream client devices via a cellular WAN network, such as network 102. Subsequently, the wireless CPE 36 receives a second message, which is destined for another network (e.g., network 102), from a client device (e.g., client devices 38-1-38-N) operating on the LAN 32 (FIG. 3, step 610). The wireless CPE 36 wirelessly sends the second message to an upstream device, such as the cellular base station 56, via the cellular WAN network (e.g., network 102) (FIG. 3, step 612).

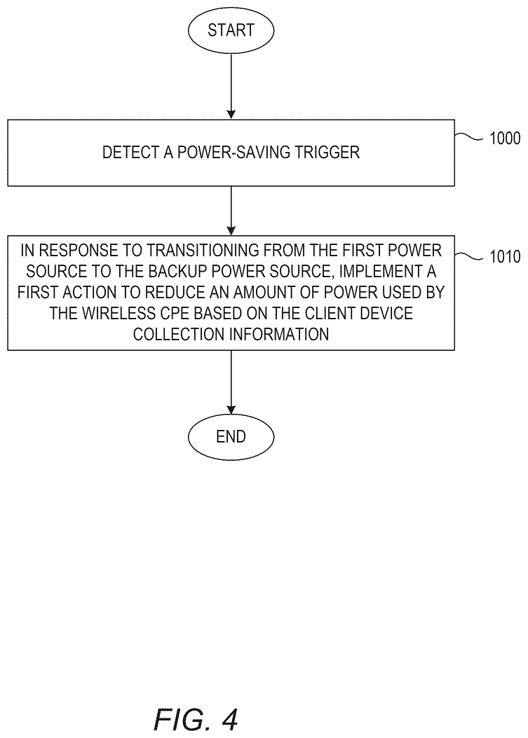

FIG. 4 is a flowchart of a method for dynamically providing power-saving operations according to one implementation of the present disclosure. FIG. 4 will be discussed in conjunction with FIG. 1. The wireless CPE 36 detects a power-saving trigger, such as a transition from a first power source (e.g., grid power source 52) to a backup power source (e.g., backup power source 54) and/or an instruction from an operator of the wireless CPE 36 to enter into a power-saving mode (FIG. 4, block 1010). In response, the wireless CPE 36 implements a first action to reduce an amount of power used by the wireless CPE 36 based on the client device collection information 48 stored in the memory 42 (FIG. 4, block 1020).

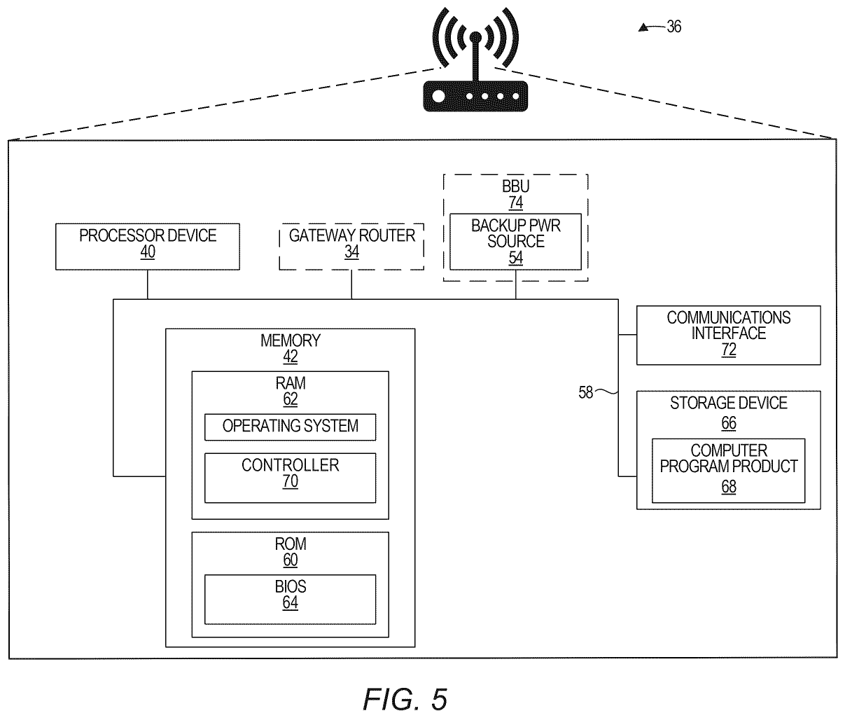

FIG. 5 is a block diagram of the wireless CPE 36 suitable for implementing the examples disclosed herein. The wireless CPE 36 is associated with the LAN 32. More particularly, in some examples, the wireless CPE 36 may be a wireless access point (AP) that connects to client devices (e.g., client devices 38-1-38-N) and communicates with the gateway router 34 to provide layer 3 connectivity to other networks (e.g., for client devices 38-1-38-N connected to the LAN 32). In other examples, the wireless CPE 36 may be an integrated wireless AP (e.g., having the gateway router 34 integrated therein) that provides layer 3 connectivity to other networks (e.g., for client devices 38-1-38-N connected to the LAN 32). The wireless CPE 36 includes the processor device 40, a system memory (e.g., memory 42), and a system bus 58. The system bus 58 provides an interface for system components including, but not limited to, the memory 42 and the processor device 40. The processor device 40 may be any commercially available or proprietary processor.

The system bus 58 may be any of several types of bus structures that may further interconnect to a memory bus (with or without a memory controller), a peripheral bus, and/or a local bus using any of a variety of commercially available bus architectures. The memory 42 may include non-volatile memory 60 (e.g., read-only memory (ROM), erasable programmable read-only memory (EPROM), electrically erasable programmable read-only memory (EEPROM), etc.), and volatile memory 62 (e.g., random-access memory (RAM)). A basic input/output system (BIOS) 64 may be stored in the non-volatile memory 60 and may include the basic routines that help to transfer information between elements within the wireless CPE 36. The volatile memory 62 may also include a high-speed RAM, such as static RAM, for caching data.

The wireless CPE 36 may further include or be coupled to a non-transitory computer-readable storage medium such as a storage device 66, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 66 and other drives associated with computer-readable media and computer-usable media may provide non-volatile storage of data, data structures, computer-executable instructions, and the like.

A number of modules can be stored in the storage device 66 and in the volatile memory 62, including an operating system and one or more program modules, which may implement the functionality described herein in whole or in part. All or a portion of the examples may be implemented as a computer program product 68 stored on a transitory or non-transitory computer-usable or computer-readable storage medium, such as the storage device 66, which includes complex programming instructions, such as complex computer-readable program code, to cause the processor device 40 to carry out the steps described herein. Thus, the computer-readable program code may comprise software instructions for implementing the functionality of the examples described herein when executed on the processor device 40. The processor device 40, in conjunction with the controller 70 in the volatile memory 62, may serve as a controller, or control system, for the wireless CPE 36 that is to implement the functionality described herein.

The wireless CPE 36 may also include a number of communication interfaces, such as a communications interface 72, that are suitable for communicating with a network (or devices connected thereto) as appropriate or desired. For instance, by way of non-limiting example, the wireless CPE 36 may include a WAN interface via which the wireless CPE 36 may communicate with other devices associated with a wired WAN network (e.g., network 100), such as a cable or fiber modem (or the like), and which facilitates communications with, for example, the service provider network 22. The wireless CPE 36 may include a cellular network interface (e.g., cellular module 50) via which the wireless CPE 36 may communicate with other devices associated with a cellular WAN network (e.g., network 102), such as an upstream cellular base station (e.g., base station 56). The wireless CPE 36 may include one or more radios (e.g., radios 44-1-44-N) operable to provide communication with one or more client devices 38-1-38-N via any of a plurality of different frequency bands. The wireless CPE 36 may include one or more wired ports (e.g., wired ports 46-1-46-2) operable to connect with an Ethernet cable or any other suitable cable.

The wireless CPE 36 may also include a backup power source 54, such as any commercially available or proprietary battery. In some examples, the wireless CPE 36 may include a battery backup unit (BBU) 74 that is integral with the wireless CPE 36 and includes the backup power source 54. As described herein, the backup power source 54 is operable to provide power to the wireless CPE 36 during power outage conditions associated with the grid power source 52.

Individuals will recognize improvements and modifications to the preferred examples of the disclosure. All such improvements and modifications are considered within the scope of the concepts disclosed herein and the claims that follow.

What is claimed is:

1. A method, comprising:
detecting, by a wireless customer premises equipment (CPE) associated with a local area network (LAN), a power-saving trigger; and
in response to detecting the power-saving trigger, implementing, by the wireless CPE, a first action to reduce an amount of power used by the wireless CPE.

2. The method of claim 1, wherein detecting the power-saving trigger comprises detecting, by the wireless CPE, a transition from a first power source to a backup power source.

3. The method of claim 2, wherein the first power source is a grid power source, and wherein the wireless CPE comprises a battery backup unit (BBU), the BBU comprising the backup power source.

4. The method of claim 2, wherein detecting the transition from the first power source to the backup power source comprises one of:
detecting, by the wireless CPE, a voltage drop indicative of an outage associated with the first power source; or
receiving, by the wireless CPE, a data transfer from the backup power source.

5. The method of claim 2, further comprising:
prior to detecting the transition from the first power source to the backup power source:
receiving, by the wireless CPE from a client device connected to the LAN, a first message destined for another network; and
sending, by the wireless CPE, the first message to an upstream device via a wired wide-area network (WAN) port; and
subsequent to detecting the transition from the first power source to the backup power source:
receiving, by the wireless CPE from the client device, a second message destined for another network; and
wirelessly sending, by the wireless CPE, the second message to an upstream cellular base station via a cellular WAN.

6. The method of claim 2, wherein the wireless CPE has a wired wide-area network (WAN) mode and a cellular WAN mode, the method further comprising:
in response to detecting the transition from the first power source to the backup power source, switching, by the wireless CPE, from the wired WAN mode to the cellular WAN mode.

7. The method of claim 2, further comprising:
prior to detecting the transition from the first power source to the backup power source, storing, by the wireless CPE, client device collection information for at least one client device connected to the LAN.

8. The method of claim 7, wherein implementing, by the wireless CPE, the first action to reduce the amount of power used by the wireless CPE further comprises:
determining, by the wireless CPE based on the client device collection information, a connection type of the at least one client device; and
wherein implementing, by the wireless CPE, the first action to reduce the amount of power used by the wireless CPE further comprises implementing, by the wireless CPE, the first action to reduce the amount of power used by the wireless CPE based on the connection type of the at least one client device.

9. The method of claim 1, wherein detecting the power-saving trigger comprises receiving, by the wireless CPE, an instruction to enter into a power-saving mode.

10. The method of claim 1, wherein the wireless CPE is operable to communicate with a client device via any of a plurality of different frequency bands, and wherein implementing the first action to reduce the amount of power used by the wireless CPE comprises:
determining, by the wireless CPE, that a first client device connected to the LAN communicates with the wireless CPE via a first frequency band of the plurality of different frequency bands; and
disabling, by the wireless CPE, a radio of the wireless CPE that implements the first frequency band.

11. The method of claim 10, wherein implementing the first action to reduce the amount of power used by the wireless CPE further comprises:
determining, by the wireless CPE, that a second client device connected to the LAN communicates with the wireless CPE via a second frequency band of the plurality of different frequency bands; and
in response to determining that the second client device connected to the LAN communicates with the wireless CPE via the second frequency band of the plurality of frequency bands:
determining, by the wireless CPE, a bandwidth setting for a radio of the wireless CPE that implements the second frequency band;
determining, by the wireless CPE, a radio chain setting for the radio of the wireless CPE that implements the second frequency band; and
configuring, by the wireless CPE, the radio of the wireless CPE that implements the second frequency band based on the bandwidth setting and the radio chain setting.

12. The method of claim 11, wherein:
determining the bandwidth setting for the radio of the wireless CPE that implements the second frequency band comprises:
determining, by the wireless CPE, a total throughput required to service the second client device; and
determining, by the wireless CPE, the bandwidth setting for the radio of the wireless CPE that implements the second frequency band based on the total throughput required to service the second client device; and
determining the radio chain setting for the radio of the wireless CPE that implements the second frequency band comprises:
determining, by the wireless CPE, a signal strength of the second client device; and
determining, by the wireless CPE, the radio chain setting for the radio of the wireless CPE that implements the second frequency band based on the signal strength of the second client device.

13. The method of claim 11, wherein the first frequency band is a 6 gigahertz (GHz) frequency band, and wherein the second frequency band is one of a 5 gigahertz (GHz) frequency band and a 2.4 gigahertz (GHz) frequency band.

14. The method of claim 1, wherein the wireless CPE comprises a plurality of wired ports operable to connect with an Ethernet cable, and wherein implementing the first action to reduce the amount of power used by the wireless CPE comprises:
determining, by the wireless CPE, that a client device is connected to a first wired port of the plurality of wired ports; and
in response to determining that the client device is connected to the first wired port of the plurality of wired ports, reducing, by the wireless CPE, a bandwidth of the first wired port from a first bandwidth to a second bandwidth, wherein the wireless CPE utilizes less power to transmit at the second bandwidth than the first bandwidth.

15. The method of claim 1, wherein the wireless CPE comprises a plurality of wired ports operable to connect with an Ethernet cable, and wherein implementing the first action to reduce the amount of power used by the wireless CPE comprises:
determining, by the wireless CPE, that no client device is connected to a first wired port of the plurality of wired ports; and
in response to determining that no client device is connected to the first wired port of the plurality of wired ports, placing, by the wireless CPE, the first wired port into a low power idle mode.

16. The method of claim 1, wherein the wireless CPE is a wireless access point (AP).

17. A wireless customer premises equipment (CPE), comprising:
a memory; and
a processor device operable to:
detect a power-saving trigger; and
in response to detecting the power-saving trigger, implement a first action to reduce an amount of power used by the wireless CPE.

18. The wireless CPE of claim 17, wherein the power-saving trigger is one of:
an instruction from an operator to enter into a power-saving mode; or
a transition by the wireless CPE from a first power source to a backup power source.

19. A non-transitory computer-readable storage medium that includes executable instructions configured to cause one or more processor devices to:
detect a power-saving trigger; and
in response to detecting the power-saving trigger, implement a first action to reduce an amount of power used by a wireless customer premises equipment (CPE).

20. The non-transitory computer-readable storage medium of claim 19, wherein the power-saving trigger is one of:
an instruction from an operator of the wireless CPE to enter into a power-saving mode; or
a transition by the wireless CPE from a first power source to a backup power source.
